(19) United States
(12) Patent Application Publication
(10) Pub. No.: US 2007/0230971 A1
(43) Pub. Date: Oct. 4, 2007

(54) Quantum information transmission device

(76) Inventor: Douglas Michael Snyder, Los Angeles, CA (US)

Correspondence Address: Douglas M. Snyder, P.O. Box 551, Beverly Hills, CA, 90213, US

(21) Appl. No.: 11/348,061

(22) Filed: Feb. 6, 2006

(51) Int. Cl. H04B 10/04

(52) U.S. Cl. 398/201

(57) ABSTRACT

An invention is presented that can send binary information between locations remote from one another without the velocity limitation of the velocity of light in vacuum and that uses the following principles: 1) superposition of quantum states; 2) a developing entanglement of quantum states for spatially separated physical entities; 3) the immediate change of the quantum wave function in a measurement; 4) the shielding of one of the physical entities so that the result of a measurement on one of the physical entities is not available to the environment; 5) the possibility of undoing the measurement on the shielded physical entity by a second measurement on this same shielded entity and, as a result of undoing the first measurement, the ability to prevent the developing entanglement of quantum states for spatially separated physical entities from being established.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The field of endeavor to which the invention pertains is physics.

No relevant patents found.

Relevant Disclosure Document Deposit Request: Filed by Douglas Michael Snyder for Quantum Eraser Information Transfer Device (QEITD) [Disclosure Document No. 568160].

Following is a description of information known to me that is related to my invention. Also, this description references specific problems involved in the prior art (and accompanying technology) to which my invention is drawn.

Scully, Englert, and Walther adapted the classic double-slit experiment in quantum mechanics, examples of which have been described by Bohr and Feynman, to demonstrate the quantum eraser effect (FIG. 1).^{1,2,3} As seen in FIG. 1, the micromaser cavity system is physically separated from the double-slit screen where traditionally interference or the lack thereof is considered to develop due to whether or not the screen is fixed or instead, for example, on rollers.² In the classic double-slit experiment where the double-slit screen is fixed in place, one obtains interference with the passage of particles through it (FIG. 2). In the classic double-slit experiment, the wave function for the particle passing through the double-slit screen is:
Ψₜₒₜₐₗ=1/√2[ψ_{L}+ψ_{R}],
where ψ_{L} and ψ_{R} represent the component wave functions associated with slits L and R. The distribution at the detection screen demonstrates interference and is given by P where:
P=|Ψₜₒₜₐₗ|²=½[|ψ_{L}(r)|²+|ψ^{R}(r)|²+ψ_{L}(r)*ψ_{R}(r)+ψ_{R}(r)*ψ_{L}(r)].
If, on the other hand, the screen is placed on rollers, one loses interference and obtains which-way information concerning the passage of the particles through the double-slit screen (FIG. 3).^{A} The wave function for the particle when the double-slit screen on rollers is either:
Ψ_{particle}=ψ_{L}
or
Ψ_{particle}=ψ_{R}
The distribution at the detection screen does not demonstrate interference and is given by P where:
P=|ψ_{L}(r)|²+|ψ_{R}(r)|².

By physically separating the micromaser cavity system from the double-slit screen, Scully, Englert, and Walther showed that a change from interference to which-way information for atoms passing through the double-slit screen was not dependent on a distinct physical interaction between the atoms and the double-slit screen occurring as the atoms pass through it.^{B} The double-slit screen was always fixed in place in their experiment. Moreover, they demonstrated that the atoms passing through the micromaser cavity system were unaffected in their motion by their passage through the micromaser cavity system with regard to any variable involving their motion that could alter their interaction with the double-slit screen from what it would have been had there been no micromaser cavity system in the experiment.^{C} Instead, whatever change happened at the double-slit screen was due to an effect of the atoms' passage through the micromaser cavity system that did not affect any relevant variables of their motion. This effect concerned an atom's spontaneously emitting a photon into one of the two micromaser cavities comprising the micromaser cavity system that at first does not contain any photons.^{D} The presence of this photon emitted by an atom in one or the other of the micromaser cavities provided the possibility of obtaining which-way information concerning the specific path of the atom through the cavity system should the measurement of the photon's location be completed. When the photon is emitted by the atom, it is only known that the photon is in one or the other of the micromaser cavities. It is not known, though, into which specific micromaser cavity the photon was emitted. The atom's emission of a photon into one of the two micromaser cavities was a measurement of the location of the photon even though it did not provide information as to the specific micromaser cavity into which the atom emitted the photon.

Scully and his colleagues attempted to show that complementarity and not the uncertainty principle, which they maintained involved a physical interaction between the atom and the double-slit screen through which it passed, was responsible for the development, or absence, of interference. The double-slit screen retained its capacity to demonstrate interference or the lack thereof, but now this capacity was tied to what occurred with the atom's passage through the micromaser cavity system.^{E} In other words, the wave functions of the photon emitted in the micromaser cavity system and the atom passing through the double-slit screen were now entangled. A one-to-one correspondence developed between the photon emitted by an atom into a specific micromaser cavity and the atom's subsequent passage through a specific slit in the double-slit screen. Importantly, this entanglement occurred over time, specifically between the time the atom emitted the photon in one of the micromaser cavities and the time that the atom subsequently traveled through the double-slit screen. It should be noted that before the atom passing through the micromaser cavity system emitted a photon in the micromaser cavity system, there were no photons present in the cavity system. With the laser, micromaser cavities, shutters, and photodetector enabled and before the shutters are opened and the photodetector exposed, the wave function after the atom exits the micromaser cavities and before it reaches the double-slit becomes:
Ψ(r)ₜₒₜₐₗ=1/√2[ψ_{L}(r)|1_{L}0_{R}>+ψ_{R}(r)|0_{L}1_{R}>]|b> (1)
where b is the internal state of the atom after it emits a photon, 1_{L}0_{R} represents the state where a photon is in cavity L and is not in cavity R, and 0_{L}1_{R} represents the state where a photon is in cavity R and is not in cavity L.^{F} The probability distribution is given by:
P(R)=|Ψ(r)ₜₒₜₐₗ|²=½[|ψ_{L}(r)|²+|ψ_{R}(r)|²+ψ_{L}(r)*ψ_{R}(r)<1_{L}0_{R}|0_{L}1_{R}>+ψ_{R}(r)*ψ_{L}(r)<0_{L}1_{R}|1_{L}0_{R}>]<b|b>.
The photon-cavity terms equal 0 due to their orthogonality and:
P(R)=|Ψ(r)ₜₒₜₐₗ|²=½[|ψ_{L}(r)|²+|ψ_{R}(r)|²]<b|b>
The shape of the distribution of the atoms in like that in FIG. 3, namely the one broad hump characteristic of which-way information.

Scully and his colleagues went on to show that after the atom went through the double-slit screen and the entanglement was established, one could obtain sub-interference patterns of the particle at the detection screen (depicted in FIG. 1) through opening up shutters separating the micromaser cavities and exposing a photodetector that could detect the presence of the emitted photon. The sum of these sub-interference patterns remained the one broad hump distribution characteristic of the loss of interference and the presence of which-way information (like the distribution in FIG. 3). They called their method of obtaining these sub-interference patterns quantum erasure.^{G} Experiments involving a quantum eraser provide support for their predictions.^{5,6}

Scully and his colleagues converted the wave function in their experiment (Eq. 1) to one expressed in terms of symmetric and anti-symmetric wave functions. They defined symmetric and anti-symmetric atomic states and states of the radiation fields inside the micromaser cavities:
ψ_{S}(r)=1/√2[ψ_{L}(r)+[ψ_{R}(r)]
ψ_{A}(r)=1/√2[ψ_{L}(r)−[ψ_{R}(r)]
|1_{S},0_{A}>=1/√2[|1_{L}0_{R}>+0_{L}1_{R}>]
|0_{S},1_{A}>=1/√2[|1_{L}0_{R}>−|0_{L}1_{R}>]
The converted wave function is:
Ψ(r)ₜₒₜₐₗ=1/√2[ψ_{S}(r)|1_{S},0_{A}>+ψ_{A}(r)|0_{S},1_{A}>]|b> (2)
|Ψ_{S}(r)1_{S},0_{A}> represents the state where the photon will be detected by the photodetector when the two shutters are opened and the photodetector exposed, and |ψ_{A}(r)0_{S},1_{A}> represents the state where the photon will not be detected by the photodetector. The probability of each occurring is ½. With the opening of the shutters, the exposure of the photodetector, and the overlap of the component wave functions for the single photon, the converted wave function becomes the appropriate wave function for describing the system of the atom and photon. The converted wave function provides a good description of the measurement possibilities regarding the photon when the shutters are opened and the photodetector exposed.

It was noted that the sum of these sub-interference patterns obtained by Scully and his colleagues remained the one broad hump distribution characteristic of the loss of interference and the presence of which-way information (like the distribution in FIG. 3). In order to obtain the sub-interference patterns one had to correlate: 1) the specific event that occurred when the shutters between the two micromaser cavities were opened and the photodetector exposed (whether the photon that had been located in one of the two micromaser cavities was or was not detected by the photodetector), and 2) the detection of the atom associated with the photon at the detection screen. The correlations cannot be developed until after atom is detected at the detection screen. In their experiment, it was not possible to use the sub-interference patterns to send information from the site of the micromaser cavities to near the site of the detection screen for the atoms by locating the double-slit screen near the site of the detection screen.

### NOTES FOR BACKGROUND OF THE INVENTION

^{A} Einstein essentially originated the idea of introducing latitude in the motion of the double-slit screen (i.e, not fixing the screen in one position). He suggested, though, that a single-slit screen that is placed in front of the anchored double slit screen has this latitude. As Bohr noted², the analysis of what occurs at the detection screen is independent of whether the single-slit screen or the following double-slit screen has this latitude in its motion.

^{B} Scully and his colleagues¹ wrote, “We have found a way, based on matter-wave interferometry, and recent advances in quantum optics, namely the micromaser and laser cooling, to obtain which-path or particle-like information without scattering or otherwise introducing large uncontrolled phase factors into the interfering beams. To be sure, we find that the interference fringes disappear once we have which-path information, but we conclude that this disappearance originates in correlations between the measuring apparatus and the systems being observed” (p. 111). They also wrote, “It is simply the correlations between the detectors (micromaser cavities) and the atomic beams which are responsible for the loss of coherence (interference fringes) in the present experimental arrangement” (P. 113).

^{C} For example, Scully and his colleagues¹ wrote, “The de Broglie wave length of the atom is, therefore, not affected when a cavity photon is emitted, and so we have an experiment which is ‘so delicate that it does not disturb’ the interference pattern” (p. 113). They also wrote, “We emphasize once more that the micromaser welcher Weg detectors are recoil-free; there is no significant change in the spatial wave function of the atoms” (P. 114).

^{D} Scully and his colleagues used Rydberg states of rubidium, specifically the transition from 63p_{3/2} to 61d_{5/2.} as the atom passed through the micromaser cavity system and spontaneously emitted a photon. The resonant micromaser cavities operated at about 21 GHz. These specifications were consistent with states used in various experiments. In particular, these states were used by Rempe, Walther, and Klein.^{7,8}

^{E} Regarding the significance of the double-slit screen, Scully and his colleagues wrote¹ regarding their experimental setup, “[Disregarding the laser and micromaser cavities,] a set of wider slits collimates two atom beams which illuminate the narrow slits where the interference pattern originates” (P. 112). The double-slit screen remains important as regards the atomic distribution at the detection screen with the introduction of the laser and micromaser cavities, as they also wrote, “[micromaser] cavities containing no photons initially store which-path information [with the atom's emitting the photon in one of the cavities in the micromaser cavity system] and therefore the interference pattern is lost. It [the distribution of the atoms at the detection screen] is changed to the incoherent superposition . . . of one-slit patterns” (P. 114) The atom's passage through the double-slit screen is responsible for the form of the distribution, namely superposed one-slit patterns, characteristic of which-way information.

^{F} The wave function is provisional due to the photon's being “hidden” in the micromaser cavity system and not knowing the specific cavity that the photon is in. Altering the experimental circumstances in a suitable manner may interrupt the development of the entanglement which becomes fully developed with the passage of the atom through the double-slit screen.

^{G} Scully and his colleagues relied on the “hidden” character of the photon in their prediction of the atomic distribution sub-interference patterns. If the photon were not “hidden” and it was known into which specific micromaser cavity the atom emitted the photon, they would not have derived Eq. 1. The derivation of Eq. 1 relies on the possibility that the photon was emitted in either one or the other of the micromaser cavities.

### REFERENCES FOR BACKGROUND OF THE INVENTION

¹M. O. Scully, B. G. Englert, and H. Walther, “Quantum optical tests of complementarity.” Nature (London), 351, 111-116, 1991.
²N. Bohr, Discussion with Einstein on epistemological problems in atomic physics. In P. A. Schilpp, Albert Einstein: Philosopher-scientist (vol. 1) (pp. 199-241). LaSalle Ill.: Open Court, 1949/1970.

³R. P. Feynman, R. B. Leighton, and M. Sands. The Feynman Lectures on Physics: Quantum Mechanics (vol. 3). Reading: Massachusetts: Addison-Wesley, 1965.
⁵Y. H. Kim, R. Yu, S. P. Kulik, Y. Shih, and M. O. Scully, “Delayed-‘choice’ quantum eraser.” Phys. Rev. Lett., 84, 1-5, 1999.
⁶S. P. Walborn, M. O. Terra Cunha, S. Padua, and C. H. Monken, “Double-slit quantum eraser.” Phys. Rev. A, 65, 033818-1-033818-6, 2002.
⁷ S. Haroche, and D. Kleppner. “Cavity quantum electrodynamics.” Phys. Today, 42, 24-30 (January, 1989).
⁸G. Rempe, H. Walther, and N, Klein, Observation of quantum collapse and revival in a one-atom maser. Phys. Rev. Lett., 58, 353-356, 1987.

### BRIEF SUMMARY OF THE INVENTION

Consider the situation where the scenario proposed by Scully and his colleagues¹ is changed so that there is no photodetector and the single shutter between the micromaser cavities is opened before the atom reaches the double-slit screen (FIGS. 4, 5).^{A} In this case, the entanglement between the photon's being emitted in a specific micromaser cavity and the atom's subsequent passage through a specific slit has not been established. What happens is that the two wave function components for the photon in the micromaser cavity system (|1_{L}0_{R}> and |0_{L}1_{R}>) that at first represent the possibilities of the photon's being in either one or the other of the micromaser cavities come to overlap in the one expanded micromaser cavity. Very importantly, these wave functions maintain their symmetry as they expand.^{B} By the time the atom reaches the double-slit screen, the potential one-to-one correspondence between the photon's being emitted in a specific micromaser cavity and the atom's subsequent passage through a specific slit has been lost. The system of the atom at the double-slit screen and the emitted photon in the expanded micromaser cavity is represented by the wave function:
Ψ(r)ₜₒₜₐₗ=[1/√2[ψ(r)_{L}+ψ(r)_{R}]][1/√2[|1_{L}0_{R}>+0_{L}1_{R}>]]|b> (1)
where [1/√2[|1_{L}0_{R}>+|0_{L}1_{R}>]] represents the overlapping component wave functions for the single photon which before the opening of the shutter indicated the possibility of the photon being found specifically in either one or the other of the micromaser cavities. Orthogonality of the component wave functions representing the single photon is preserved after the opening of the shutter. The wave function for the system of the atom and photon also shows that the developing entanglement with regard to the atom's emitting a photon in a specific micromaser cavity and the atom's subsequent passage through a specific slit in the double-slit screen has been effectively lost with the overlap of the component wave functions representing the single photon. The overlap of these wave functions representing the single photon is represented by taking their sum.^{C} The distribution of atoms at the detection screen is found in P where:
P(R)=|Ψ(r)ₜₒₜₐₗ|²=¼[|ψ(r)_{L}|²+|ψ(r)_{R}|²+ψ_{L}(r)*ψ_{R}(r)+ψ_{R}(r)*ψ_{L}(r)][[<1_{L}0_{R}|+<0_{L}1_{R}|][|1_{L}0_{R}>+|0_{L}1_{R}>]]<b|b>
The photon-cavity term equals 1 due to its normalization and:
P(R)=|Ψ(r)ₜₒₜₐₗ|²=¼[|ψ_{L}(r)|²+|ψ_{R}(r)|²+ψ_{L}(r)*ψ_{R}(r)+ψ_{R}(r)*ψ_{L}(r)]<b|b>
In terms of the symmetric and anti-symmetric transformation equations for the atomic states and the states of the radiation in the micromaser cavities noted earlier, the wave function for the system is:
Ψ(r)ₜₒₜₐₗ=[ψ_{S}(r)|1_{S},0_{A}>|b>] (2)
|ψ_{S}(r)|1_{S},0_{A}> represents the state where the photon and the atom are represented only by their respective symmetric wave functions. The distribution of the atoms at the double-slit screen should exhibit complete interference like the distribution in FIG. 2 where there is no micromaser cavity system or laser. Opening the single shutter between the micromaser cavities after the atom leaves the micromaser cavity system and before the atom reaches the double-slit screen is a measurement of the location of the photon.

Since the wave function components of the single photon for the left and right micromaser cavities maintain their symmetry as they expand once the single shutter is opened, it might be useful to explicitly consider 1/√2[|1_{L}0_{R}>+|0_{L}1_{R}>] in terms of symmetric and anti-symmetric wave functions for the single photon:
|1_{L}0_{R}>=1/√2[|1_{S}0_{A}>+|0_{S}1_{A}>] (3)
|0_{L}1_{R}>=1/√2[|1_{S}0_{A}>−|0_{S}1_{A}>].^{D} (4)
Then:
1/√2[|1_{L}0_{R}>+|0_{L}1_{R}>]=1/√2[[1/√2[|1_{S}0_{A}>+|0_{S}1_{A}>]]+[1/√2[|1_{S}0_{A}>−|0_{S}1_{A}>]]]1/√2[|1_{L}0_{R}>+|0_{L}1_{R}>]=|1_{S}0_{A}>.^{E} (5)

It should be noted that Eqns. 3 and 4 hold whether: 1) the shutter is closed and the component wave functions for the photon are confined to one or the other of the micromaser cavities, or 2) the shutter is opened between the two micromaser cavities and the component wave functions for the photon expand into what is now a single micromaser cavity. That Eqns. 3 and 4 hold in either condition 1 or condition 2 means that the component wave functions maintain their symmetry as they expand.

One can thus alter a distribution of physical entities, in the present case the atoms passing through the quantum information transmission device, through an action that does not involve a direct physical interaction with those entities. The action in the proposed experiment is opening the shutter between the micromaser cavities after the atom exited the micromaser cavity system but before the atom reaches the double-slit screen. The action can affect the development of the atomic distribution at the detection screen (or other detection device). The capability to alter the distribution of atoms at the detection screen through an action that does not involve a direct physical interaction with the atoms depends on the “hidden” character of the photon emitted by an atom passing through the micromaser cavity system.

One can in principle make the distance between the double-slit screen and the detection screen very large and delay the decision whether or not to open the single shutter separating the two micromaser cavities until just before the atom reaches the detection screen. Repetition of the experimental procedure could be managed so as to create distinct atomic distributions at the detection screen, either the interference pattern like in FIG. 2 or the which-way pattern like in FIG. 3. These two patterns could be used to represent binary bits of information. In the procedure proposed here, it is possible to use the interference distribution pattern or the which-way distribution pattern to send binary information from the site of the micromaser cavities to near the site of the detection screen for the atoms and for this information to then be recorded in the atomic distributions at the detection screen.

Ghirardi, Rimini, and Weber's argument on the “impossibility of superliminal transmission” (p. 298) in quantum mechanics, as does Eberhard's on the same issue, assumes a single set of possible measurement results.^{2,3} For Ghirardi and colleagues, this single set of possible measurement results is represented by the statistical operator Q⁰. For Eberhard, this single set of possible measurement results is represented by a statistical distribution Q(λ) and two associated conditional probability functions involving possible measurement results at two separate physical locations. In the argument presented here, there are two possible sets of possible measurement results, regarding both the photon and the atom which are in the process of becoming entangled. One set concerns where the shutter separating the two micromaser cavities remains closed, and one set concerns where the shutter is opened before the atom reaches the double-slit screen. Thus, Ghirardi, Rimini, and Weber's argument, as well as Eberhard's, are not applicable to the scenario discussed here. Even though information transfer with the quantum information transfer device is not subject to the limitation of the velocity of light in vacuum, the device does not violate the limitation on the velocity of light in vacuum in the special theory of relativity as regards the transfer of anything physical.⁴ The atom passing through the quantum information transfer device does not travel faster than the velocity of light.

As noted, the results discussed allow for the possibility of a transfer of information when a number of atoms are considered. Allow that a sufficient number of atoms (perhaps 100) are sent through this scenario to allow a distribution pattern to form when the atoms are detected. Consider that one has 100 pairs of micromaser cavities on a turntable, or carrel, and that each atom traverses a separate pair of micromaser cavities on the turntable. That is, after each run with an atom, the turntable rotates one position so that a new set of paired micromaser cavities is set in place for a new run.^{F}

If the shutter between the micromaser cavities for each pair is left closed after the pair of micromaser cavities is set in position for a run, a one-broad hump distribution pattern for the atoms characteristic of which-way information will develop (FIG. 6). If the shutter between these micromaser cavities is opened before the atom reaches the double-slit screen, a distribution based on a Young-like interference pattern for the atoms will develop (FIG. 7). Due to the developing entanglement of the atom's emitting a photon into one of the two micromaser cavities and the atom's subsequent passage through the double-slit screen, the atom can be a great distance from the micromaser cavity system and the photon contained therein before it reaches the double-slit screen and the wave function of the atom can still change immediately upon the opening of the shutter between the micromaser cavities with the loss of the developing entanglement between the atom's emitting a photon into one of the two micromaser cavities and the atom's subsequent passage through the double-slit screen (FIGS. 8, 9).^{G}

In this scenario with the shutter remaining closed, let the one-hump pattern formed from 100 atoms, for example, represent a binary “0.” In this scenario with the shutter open, let the interference pattern formed from 100 atoms represent a binary “1.” One thereby has the basis for the transfer of information in the form of binary bits.

One just has to be able to distinguish the results for different runs of 100 atoms each at the site, or sites, where the atoms are detected to send multiple bits of information. Distinguishing between sets of results of 100 runs each can be achieved by sending each set of atoms in series over time using a single pair of micromaser cavities. Another example would be to use 1000 of the turntables noted above, operating simultaneously in a parallel setup and sending their respective photons along 1000 separate paths to 1000 detection screens electronically hooked together for summing pattern information from each screen (FIG. 10). In this way, one could send a brief message of 1000 bits to locations remote from the photons, each photon being each released by the atom into one of a pair of micromaser cavities as each atom traversed the micromaser cavity system.

### NOTES FOR BRIEF SUMMARY OF THE INVENTION

^{A}In the quantum information transfer device, Rydberg states of rubidium can be used, specifically the transition from 63p_{3/2} to 61d_{5/2.} as the atom passes through the micromaser cavity system and spontaneously emits a photon. The resonant micromaser cavities operate at about 21 GHz and do not contain any photons before the atom passes through the micromaser cavity system and emits a photon. Instead of rubidium other Rydberg states of atoms can be used in conjunction with suitably adjusted resonant micromaser cavities such that the excited atom is does not emit a photon until the atom enters the micromaser cavity system where it has a probability of one of spontaneously emitting a photon in one or the other of the micromaser cavities.

^{B}The significance of this symmetry being maintained will be discussed in more detail shortly.

^{C}Since the component wave functions for the single photon in the micromaser cavity system are for that single photon and the single photon is “hidden” in the micromaser cavity system, when the component wave functions overlap there is no way to distinguish between them. If the photodetector between the two micromaser cavities were installed prior to sending the atom into the micromaser cavity system (as Scully and his colleagues did), one could distinguish the two component wave functions after the shutters are opened and the photodetector is exposed. In the quantum information transmission device, there is no photodetector.

^{D}Except for the normalization constants, these wave functions can be obtained by adding and subtracting |1_{S},0_{A}>=1/√2[|1_{L}0_{R}>+|0_{L}1_{R}>] and |0_{S},1_{A}>=1/√2[|1_{L}0_{R}>−|0_{L}1_{R}>] defined by Scully and his colleagues.

^{E}After interrupting the development of the entanglement between the atom's emitting the photon in one of the micromaser cavities and the atom's subsequent passage through the fixed double-slit screen by opening the shutter before the atom reaches the double-slit screen, it may still be possible to establish which-way information and the associated one broad hump atomic distribution, like in FIG. 3. This could occur if the shutter is closed before the atom reaches the double-slit screen and the atom subsequently passes through the double-slit screen while the shutter remains closed. The system of the atom and the photon would then be characterized by Eq. 1 in “Background of the Invention.” The process of entanglement would be revived in this process.

^{F}A single run consists of an atom:
A. leaving the atom source toward the micromaser cavity system;
B. being excited by a laser into a state where it will spontaneously emit a photon in the micromaser cavity system;
C. entering the micromaser cavity system;
D. spontaneously emitting a photon in the micromaser cavity system;
E. exiting the micromaser cavity system;
F. passing through the double-slit screen;
G. being detected at a detection device.

In addition, between steps E and F, it is possible that the single shutter separating the pair of micromaser cavities is opened.

^{G}Opening the shutter constitutes a measurement of the spatial location of the photon, in this case that the emitted photon is in he enlarged micromaser cavity formed from the two smaller micromaser cavities that had been separated by a single shutter.

### REFERENCES FOR BRIEF SUMMARY OF THE INVENTION

¹M. O. Scully, B. G. Englert, and H. Walther, “Quantum optical tests of complementarity.” Nature (London), 351, 111-116, 1991.
²Ghirardi, G. C., Rimini, A., Weber, T. A general argument against superluminal transmission through the quantum mechanical measurement process. Lettere al Nuovo Cimeno, vol. 27, n. 10, 293-298, 8 Marzo 1980.
³Eberhard, P. H. Bell's theorem and the different concepts of locality. II Nuovo Cimento, vol. 46 B, n. 2, 392-419, 11 Agosto 1978.
⁴Einstein, A. (1952). On the electrodynamics of moving bodies. In H. Lorentz, A. Einstein, H. Minkowski, and H. Weyl (Eds.), The principle of relativity, a collection of original memoirs on the special and general theories of relativity (pp. 35-65) (W. Perrett and G. B. Jeffrey, Trans.). New York: Dover. (Original work published 1905)

### BRIEF DESCRIPTION OF THE SEVERAL VIEWS OF THE DRAWING

FIG. 1—Overview of basic features of quantum eraser experiment described by Scully and colleagues. There are two shutters, one shutter between one micromaser cavity and the photodetector and one shutter between the other micromaser cavity and the photodetector. Two sub-interference patterns are shown that sum to the one-hump distribution characteristic of which-way information concerning the path of the atoms to the detection screen. The sub-interference patterns depend on correlating: 1) whether the photon that had been located in one of the two micromaser cavities was or was not detected by the photodetector when the shutters were opened and 2) the detection of the atom that had emitted the photon in the micromaser cavity system at the detection screen.

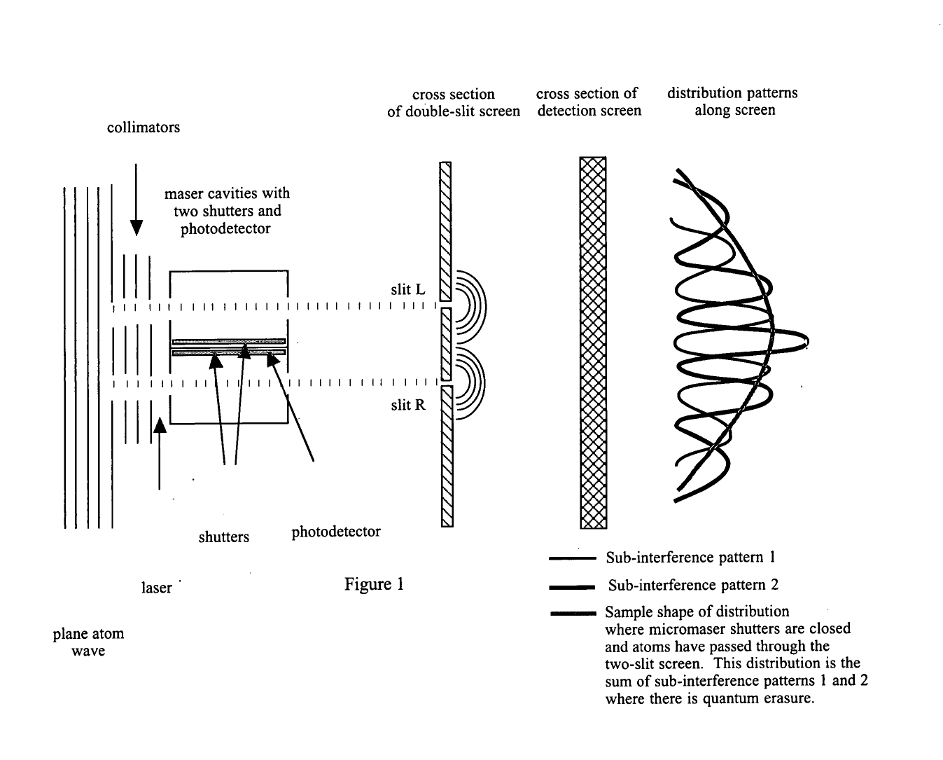

FIG. 2—Overview of thought experiment (i.e., gedankenexperiment) in which the distribution of electrons passing through an anchored double-slit screen indicates interference in the wave functions of the electrons. The interference pattern depends on the electron passing through both slits in the double-slit screen.

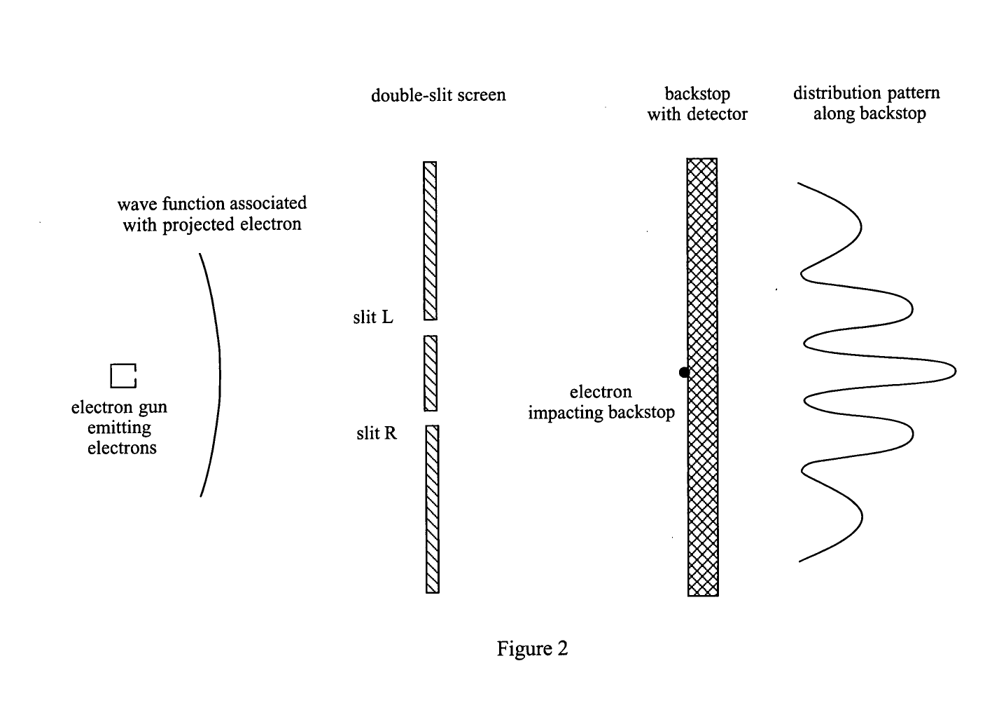

FIG. 3—Overview of thought experiment (i.e., gedankenexperiment) in which the distribution of electrons passing through a double-slit screen on rollers is used to determine through which slit in the double-slit screen the electron passed on its way to the detection screen. The distribution of electrons at the detection screen indicates that each electron passed through either one or the other slit in the double-slit screen on its path to the detector device.

FIG. 4—Overview of basic features of quantum information transmission device with the single shutter between the micromaser cavities remaining in closed position. There is no photodetector. The distribution of the atoms at the detection screen is the one broad hump characteristic of which-way information concerning the path of the atoms to the detection screen. The atom passed through only one slit in the double-slit screen, although it is not known through which specific slit the atom passed.

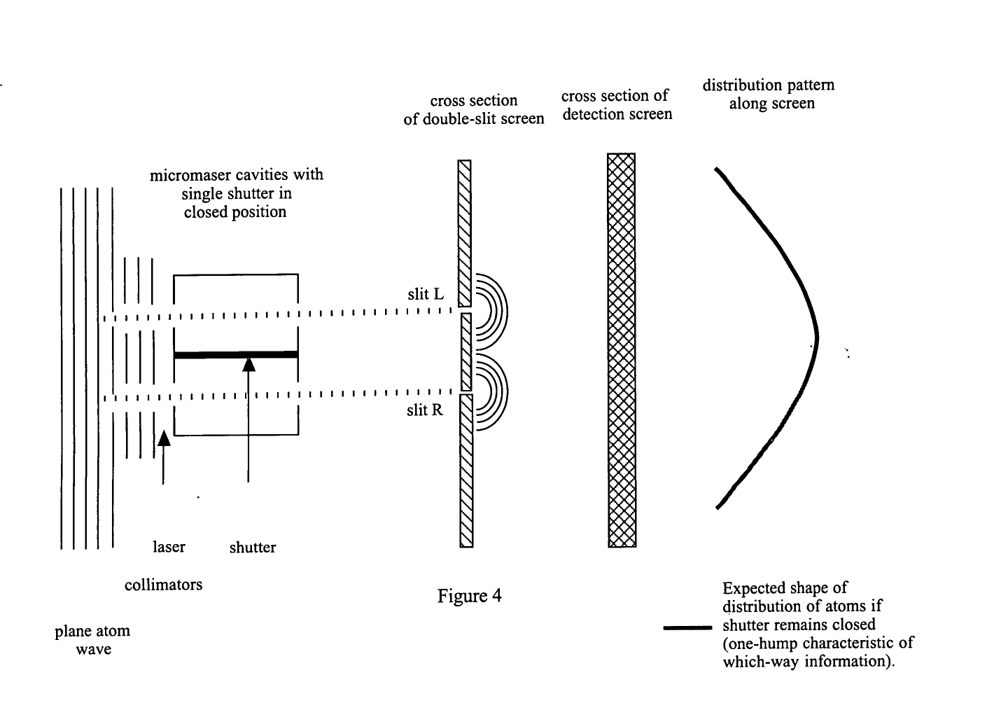

FIG. 5—Overview of basic features of quantum information transmission device with the single shutter opened after the atom exists micromaser cavity where it emitted a photon and before the atom reaches the double-slit screen. There is no photodetector. The distribution of the atoms at the detection screen is the distribution pattern characteristic of interference (the lack of which-way information concerning the path of the atoms to the detection screen).

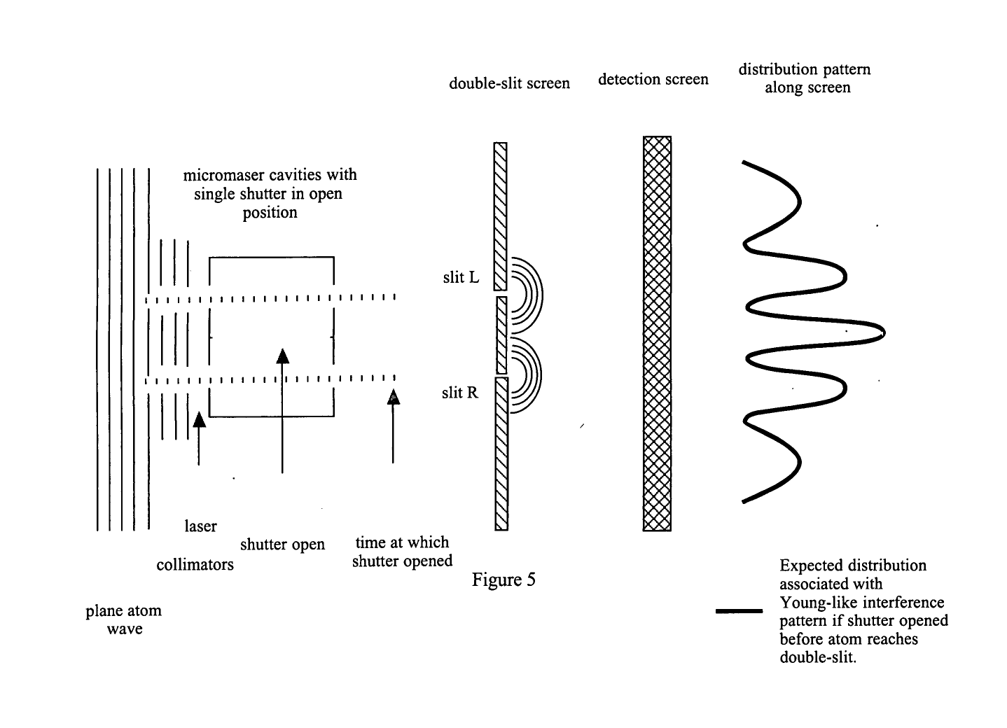

FIG. 6—Overview of basic features of quantum information transmission device where double-slit screen is placed near the detection screen depicting which-way information and the single shutter between the micromaser cavities remains in closed position. If repeated many times, the atomic distribution at the detection screen is the one broad hump characteristic of which-way information. One can decide whether to obtain “which-way” information or not to obtain such information (and show interference) until the atom passes through the double-slit screen.

FIG. 7—Overview of basic features of quantum information transmission device where double-slit screen is placed near the detection screen depicting the lack of which-way information. If repeated many times, the atomic distribution at the detection screen is the many narrow hump distribution characteristic of interference (no which-way information). One can decide whether to obtain “which-way” information or not to obtain such information (and show interference) until the atom passes through the double-slit screen.

FIG. 8—Overview of basic features of quantum information transmission device with carrel with many paired micromaser cavity systems where double-slit screen is placed near the detection screen. The carrel turns clockwise one position (i.e., a new set of paired micromaser cavities is set in place for a new run) after each run is completed. After a set of paired micromaser cavities is rotated into place for a run, the shutter is left closed for the run. The distribution pattern of atoms at the detection screen is one broad hump pattern characteristic of which-way information. In real form, the carrel would possess at least 100 paired micromaser cavity systems needed to produce a recognizable distribution pattern.

FIG. 9—Overview of basic features of quantum information transmission device with carrel with many paired micromaser cavity systems where double-slit screen is placed near the detection screen. The carrel turns clockwise one position (i.e., a new set of paired micromaser cavities is set in place for a new run) after each run is completed. The shutter between the paired micromaser cavities set in place for a new run is opened after the atom leaves the micromaser cavity system and before the atom reaches the double-slit screen. The distribution pattern of atoms at the detection screen is the many narrow hump pattern characteristic of interference (no which-way information). In real form, the carrel would possess at least 100 paired micromaser cavity systems needed to produce a recognizable distribution pattern.

FIG. 10—Overview of set of three carrels displayed in FIGS. 8 and 9, each with many paired micromaser cavity systems where double-slit screen is placed near the detection screen. For two carrels, the shutter between the pair of micromaser cavities set in place for a run remains closed. The distribution pattern of atoms at the detection screen for each of these two carrels is the one broad hump pattern characteristic of which-way information. For one carrel (middle one), the shutter between the paired micromaser set in place for a run is opened after the atom has exited the micromaser cavity system and before the atom reaches the double-slit screen. The distribution pattern of atoms at the detection screen for this carrel is the many narrow hump pattern characteristic of interference (no which-way information). Bit detector collects one bit from each carrel system, for example “0” for the one broad hump atomic distribution pattern and “1” for the many narrow hump atomic distribution pattern. Bit collector registers 0 1 0. One could also use three paired micromaser cavity systems like in FIGS. 6 and 7, each pair operating serially to develop bits of information, instead of the carrels if each of the runs in a paired micromaser cavity system does not affect other runs in that system.

### DETAILED DESCRIPTION OF THE INVENTION

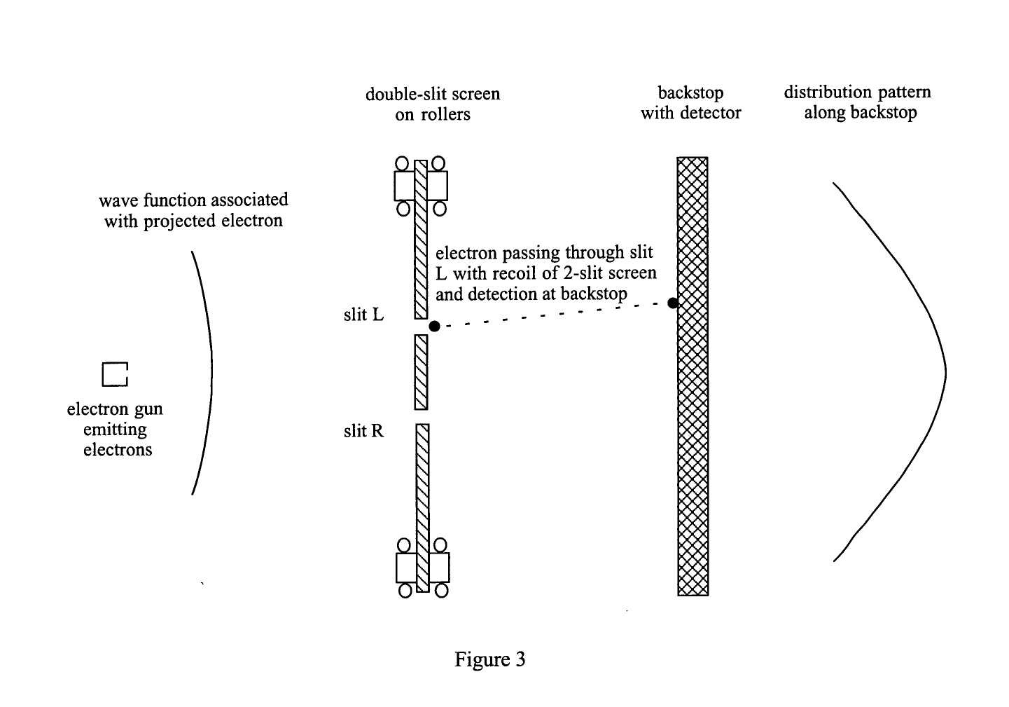

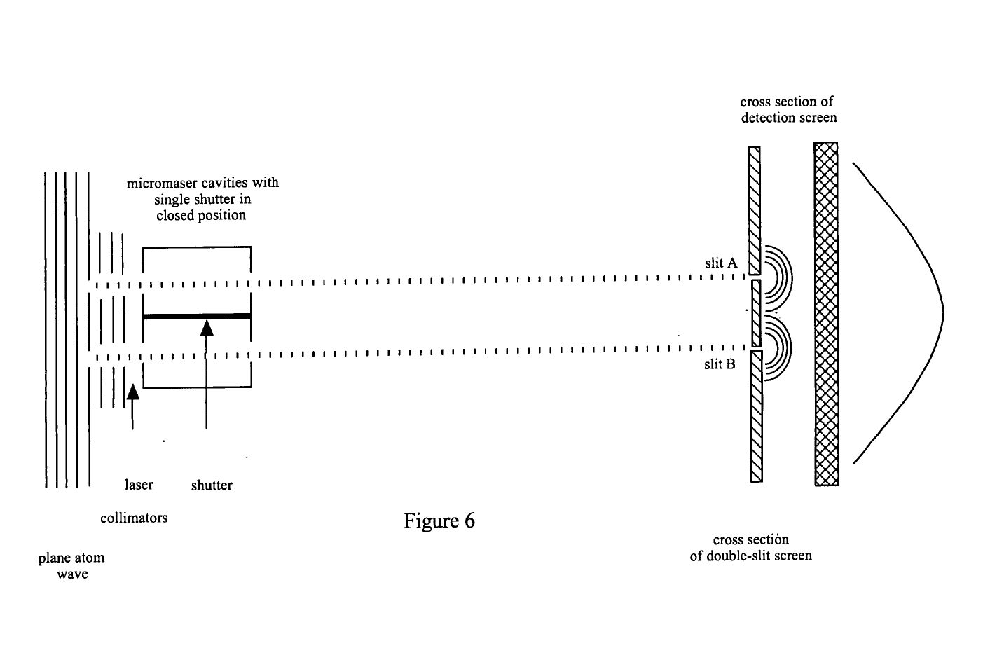

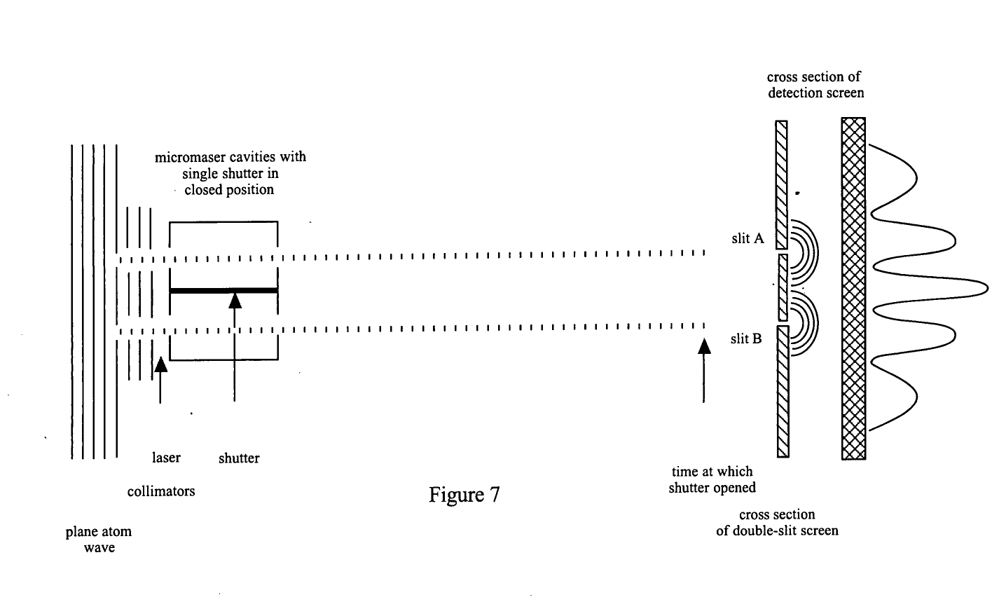

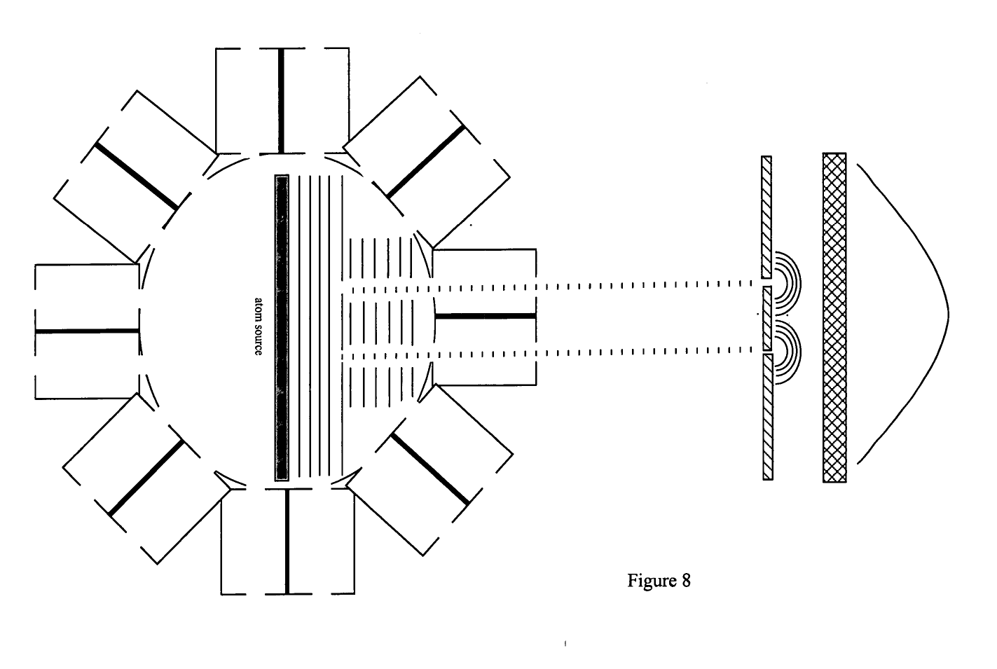

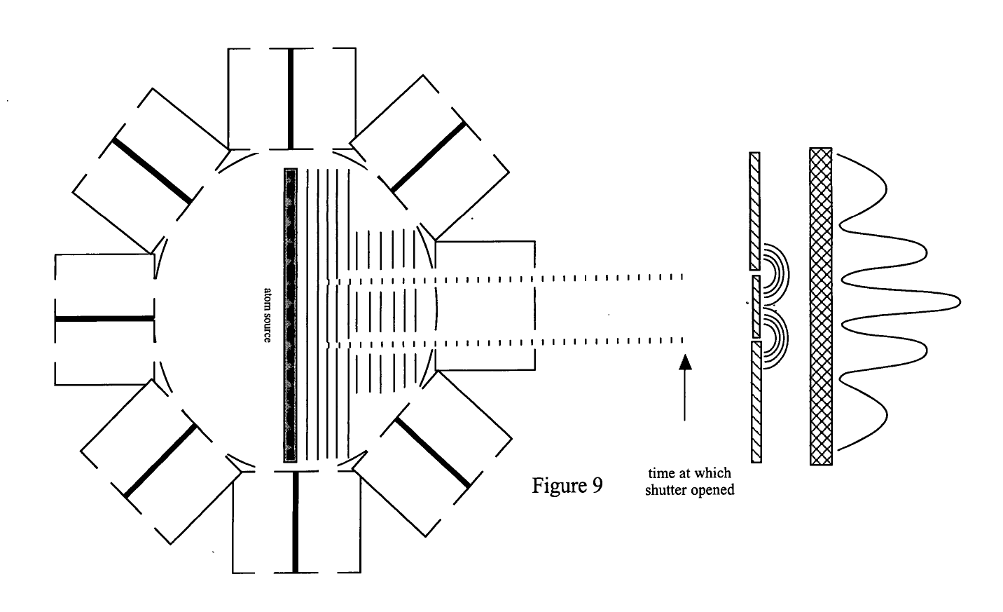

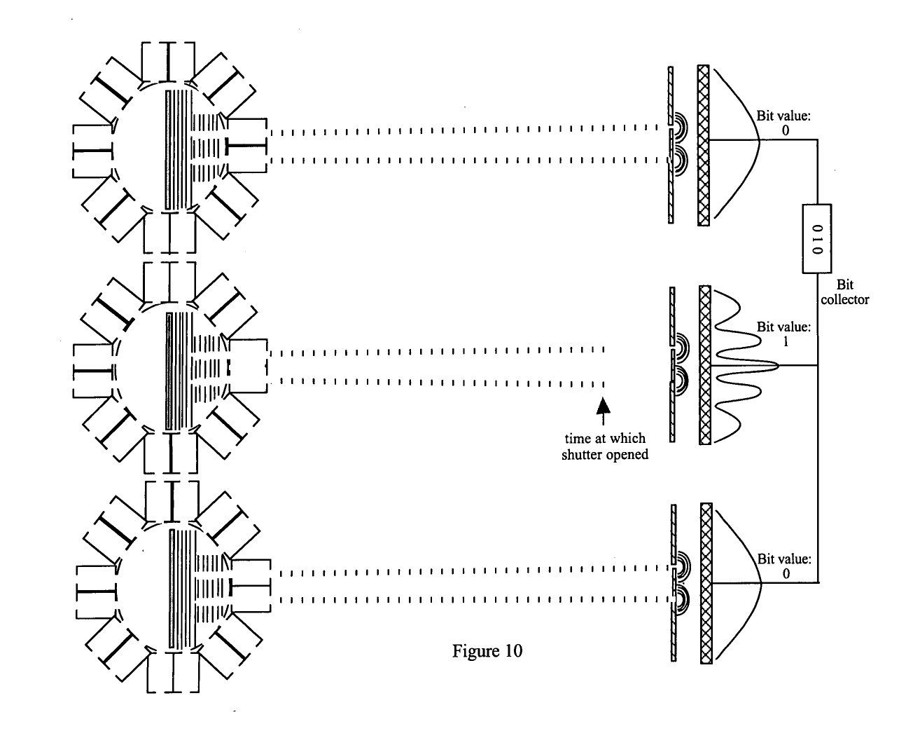

The invention can send binary information between locations remote from one another without the velocity limitation of the velocity of light in vacuum and uses the following principles: 1) superposition of quantum states; 2) a developing entanglement of quantum states for spatially separated physical entities; 3) the immediate change of the quantum wave function in a measurement; 4) the shielding of one of the physical entities so that the result of a measurement on one of the physical entities is not available to the environment; 5) the possibility of undoing the measurement on the shielded physical entity by a second measurement on this same shielded entity and, as a result of undoing the first measurement, the ability to prevent the developing entanglement of quantum states for spatially separated physical entities from being established. The invention consists of the following elements and operates in the following way:
1. A micromaser cavity system consisting of two micromaser cavities that allows for an atom passing through the cavity system to emit a photon into the cavity system without affecting the motion of the atom that emits the photon. The system must be constructed so that the specific cavity into which the photon was deposited is not known. If the basic structure of the micromaser cavities is such that one can determine into which specific cavity the photon was emitted when the atom emits the photon, opening the shutter will not change the distribution of atoms passing through the micromaser cavity system at the detection screen from the one broad hump pattern characteristic of which-way information (like that shown in FIG. 3). The micromaser system is constructed such that the cavities are separated by a common wall (i.e., or shutter) such that when the shutter is opened, there is now one enlarged cavity where there had previously been two.
   The micromaser cavities need to be constructed so that the atom passing through the cavity system will emit a photon with a probability of 1. Rydberg states of rubidium can be used, specifically the transition from 63p_{3/2} to 61d_{5/2.} as the atom passes through the micromaser cavity system and spontaneously emits a photon. The resonant micromaser cavities operate at about 21 GHz and do not contain any photons before the photon is emitted by the rubidium passing through. Rydberg states of other kinds of atoms besides rubidium can be used in conjunction with suitably adjusted resonant micromaser cavities such that the excited atom does not emit a photon until it enters the micromaser cavity system where it has a probability of one of spontaneously emitting a photon in one or the other of the micromaser cavities.
2. A source of atoms that ejects atoms toward the micromaser cavity system such that the atom has an equal chance of passing through either micromaser cavity with the shutter closed when the atom passes through. The type of atom selected and the type of micromaser cavity selected must be such that when the atom is excited it must not emit a photon until the atom enters the micromaser cavity system and inside the micromaser cavity system it emits a photon with a probability of one. The choice of micromaser and atom must be such that the emission of a photon by the atom in the micromaser cavity system must not alter the motion of the atom in any significant manner.
3. A set of collimators between the atom source and the micromaser cavity system.
4. A suitable laser placed just before the micromaser cavity system that stimulates the atom where this stimulation allows the atom to then emit a photon in the micromaser cavity system. For example, the laser excites the rubidium to a Rydberg state such as 63p_{3/2}.
5. A double slit screen where each slit is associated in a one-to-one fashion with one of the micromaser cavities such that an atom exiting one of the micromaser cavities will pass through its associated slit in the double-slit screen in the absence of opening the shutter between the micromaser cavities before the atom reaches the double-slit screen.
6. A detection screen, or other detection device, where the spatial distribution of the atoms can be recorded. For information transfer without the velocity limitation of the special theory (i.e., the velocity of light in vacuum), the double slit screen should be located near the detection screen. This positioning makes it easier for the events at 1) the micromaser cavity system (i.e., opening or leaving closed the shutter between the two cavities) and 2) at the double-slit screen (i.e., the passage of the atom through the double-slit screen) to be spacelike separated (i.e., light associated with one event cannot reach the other event).
   The invention operates in such a way that in each run of the device that spans an atom's leaving the atom source and its passage through the exciting laser, the micromaser cavity system, and the double-slit screen through to its detection at the detector:
   A. the single wall (or shutter) separating the two micromaser cavities may be opened after the atom exits the micromaser cavity system and before the atom reaches the double-slit screen (if one wants to send a specific binary bit, for example a 1) or
   B. the single wall (or shutter) is kept closed until after the atom passes through the double-slit screen (if one wants to send a different binary bit, for example a 0).
   The quantum information transmission device operates in such a way such that there are a sufficient number of runs in either format A or format B so that either a which-way atomic distribution or an interference distribution is developed. In each set of runs, a single bit (either 0 or 1) is developed. These runs can be made using a single device like a turntable, or carrel, with many paired micromaser cavity systems to develop one bit of information. The developed bit is sent from from the turntable to near the double-slit screen. The runs can also be made by a single set of paired micromaser cavities where there is a sufficient number of runs made serially in either format A or format B so that either a which-way atomic distribution or an interference distribution is developed.
   A set of carrels can be used onto which the micromaser cavity systems can be placed (FIGS. 8, 9, 10). There should be sufficient micromaser cavity systems on each carrel (at least 100) to distinguish the two different atomic distribution patterns that can be developed through manipulation of the shutter separating each pair of two micromaser cavities on the carrel. The carrel turns clockwise one position (i.e., a new set of paired micromaser cavities is set in place for a new run) after each run is completed. After a set of paired micromaser cavities is rotated into place for a run, if the shutter is left closed for the run, the distribution pattern of atoms at the detection screen is the one broad hump pattern characteristic of which-way information if this procedure is followed over many runs. If, on the other hand, the shutter between the paired micromaser cavities set in place for a new run is opened after the atom leaves the micromaser cavity system and before the atom reaches the double-slit screen, the distribution pattern of atoms at the detection screen is the many narrow hump pattern characteristic of interference (no which-way information) if this alternative procedure is followed over many runs. One could also use a single pair of micromaser cavities, like in FIGS. 6 and 7, and conduct 100 runs in a serial fashion.
   Sets of runs are repeated through running the sets according to either format A or format B noted above, or some other equivalent setup, that allows either the one broad hump atomic distribution (shutter remaining closed resulting in which-way information) or the many hillock atomic distribution (shutter opened resulting in interference) to develop in each set of runs so as to create and send many bits of information from the site of the micromaser cavity system/s to the site of the double-slit screen. To accomplish this goal of sending multiple bits of binary information, the carrels can be placed next to one another and run in parallel fashion (depicted in FIG. 10). One could also place single sets of paired micromaser cavities next to one another (depicted in FIGS. 6 and 7) and run each set serially to develop many bits of binary information in a parallel manner. One could also use only one set of paired micromaser cavities (depicted in FIGS. 6 and 7) and develop each bit in a number of runs serially that form one set of runs and then repeat this process over a number of sets of runs to develop many bits of information.
7. A bit detector that assembles the binary information from the detection devices that is sent from the site of the micromaser cavity system to the double-slit screen in the many sets of runs.

1) I claim a device that can send binary information between locations remote from one another without the velocity limitation of the velocity of light in vacuum and that uses the following principles: 1) superposition of quantum states; 2) a developing entanglement of quantum states for spatially separated physical entities; 3) the immediate change of the quantum wave function in a measurement; 4) the shielding of one of the physical entities so that the result of a measurement on one of the physical entities is not available to the environment; 5) the possibility of undoing the measurement on the shielded physical entity by a second measurement on the same shielded entity and, as a result of undoing the first measurement, the ability to prevent the developing entanglement of quantum states for spatially separated physical entities from being established.

2) The device described in claim 1 is further comprised of an atom and photon emitted by the atom in the atom's passage through a micromaser cavity system such that the motion of the atom is not affected by the atom's emission of the photon into one of the cavities in the micromaser cavity system.

3) The device described in claim 1 is further comprised of a micromaser cavity system where two micromaser cavities are separated only by a single common wall (i.e., a shutter) that can be opened and where this micromaser cavity system is inserted in the path of an atom that is excited by a suitable laser to a specified state and that will in this excited state emit a photon in the micromaser cavity system as the atom passes through; the micromaser cavities are resonant and operate at a frequency suitable for unit probability that the specific atom passing through the micromaser cavity system spontaneously emits a photon into one or the other of the micromaser cavities; the micromaser cavities are constructed so that one does not know into which specific cavity the atom emitted the photon in the atom's passage through the micromaser cavity system.

4) The device described in claim 1 is further comprised of a double-slit screen, or some other suitable instrument, that provides the possibility of interference as the atom passes through it; the double-slit screen is situated such that there exists a one-to-one correspondence between each micromaser cavity and one of the slits in this double-slit screen such that an atom exiting one of the maser cavities will pass through its associated slit in the double-slit screen in the absence of opening the common wall between the micromaser cavities; the setup of the trajectory of the atom after it leaves the atom source is such that if the shutter separating the micromaser cavities remains closed, there is a 50-50 chance that the photon is emitted into either of the micromaser cavities and a 50-50 chance that the atom passes through either of the slits in the double-slit screen.

5) The device described in claim 1 is further comprised of a detector device, or devices, whereby the spatial distribution of the atoms that pass through the micromaser cavity system and double-slit screen can be determined.

6) The device described in claim 1 operates in such a way that in each run of the device that spans an atom's leaving the atom source and its passage through the exciting laser, the micromaser cavity system, and the double-slit screen through to its detection at the detector:
A. the single wall (or shutter) separating the two micromaser cavities may be opened after the atom exits the micromaser cavity system and before the atom reaches the double-slit screen (if one wants to send a specific binary bit, for example a 1) or
B. the single wall (or shutter) is kept closed until after the atom passes through the double-slit screen (if one wants to send a different binary bit, for example a 0).

7) The device described in claim 1 operates in such a way such that there are a sufficient number of runs in either format A or format B so that either a which-way atomic distribution or an interference distribution is developed; in each set of runs, a single bit (either 0 or 1) is developed; these runs can be made using a single device like a turntable, or carrel, with many paired micromaser cavity systems to develop one bit of information; the developed bit is sent from the turntable to near the double-slit screen; the runs can also be made by a single set of paired micromaser cavities where there is a sufficient number of runs made serially in either format A or format B so that either a which-way atomic distribution or an interference distribution of the atoms is developed.

8) The device described in claim 1 and in claims 2 through 7 repeats sets of runs through running the sets according to either format A or format B in claim 6, or some other equivalent setup, that allows the one broad hump distribution (shutter remaining closed resulting in which-way information) or many hillock distribution (shutter opened resulting in interference) to develop in each set of runs; repeating sets of runs in this manner creates and sends many bits of information from the site of the micromaser cavity system/s to the site of the double-slit screen or screens.

9) The device described in claim 1 is further comprised of a bit detector to assemble the binary information from the detection devices that is sent in the many sets of runs.
